(19) United States
(12) Patent Application Publication
(10) Pub. No.: US 2005/0188416 A1
(43) Pub. Date: Aug. 25, 2005

(54) Method and device for the distribution of an audiovisual signal in a communications network, corresponding validation method and device

(75) Inventors: Tristan Halna Du Fretay, Rennes (FR); Laurent Frouin, Rennes (FR)

Correspondence Address: FITZPATRICK CELLA HARPER & SCINTO, 30 ROCKEFELLER PLAZA, NEW YORK, NY, 10112, US

(73) Assignee: CANON EUROPA NV, Amstelveen (NL)

(21) Appl. No.: 11/052,840

(22) Filed: Feb. 9, 2005

(30) Foreign Application Priority Data
Feb. 9, 2004 (FR) 04 01231

(51) Int. Cl. H04N 7/173; H04N 7/14; H04N 5/38; H04N 7/16

(52) U.S. Cl. 725/117; 348/723; 725/115; 725/116; 725/146; 725/145; 725/111

(57) ABSTRACT

A method for the distribution of an audiovisual signal, in a communications network interconnecting a plurality of terminals, from a source terminal to one or more destination terminals comprises: a step for the detection of an initializing signal; a step for the transmission of the audiovisual signal to a first group of terminals; a step for the sending of indication messages on the transmission of the audio signal to a second group of terminals; a step for the reception of confirmation messages used to determine the terminals of the second group for which the transmission of the audiovisual signal must be maintained; a step to stop the transmission of the audiovisual signals to the terminals of the second group for which the transmission of this signal must not be maintained. A method for the validation of the distribution of an audiovisual signal from a terminal source to a destination terminal in a communications network interconnecting a plurality of terminals formed by all or part of the terminals of the first group is also disclosed. Devices implementing the above methods are also disclosed.

### BACKGROUND OF THE INVENTION

1. Field of the Invention

The field of the invention is that of communications networks interconnecting a plurality of terminals. The present invention concerns a method, a device and a program to set up a connection between a source terminal and one or more destination terminals.

The invention can be applied especially but not exclusively to the setting up of a connection within a home communications network for the transfer of audiovisual signals.

2. Description of the Prior Art

The existence of a communications network in a dwelling enables the use of applications involving physically distributed terminals. For example, source terminals and destination terminals may be distributed in different rooms of the dwelling and contribute to the distribution of audiovisual (AV) signals. Thus, it is not necessary for the source terminal to be close to the destination terminal or integrated with it. For example, in the case of a network consisting of a videocassette recorder and several television sets distributed in different rooms of a house, the user is not obliged to watch a recording on the television set that is next to the videocassette recorder. He can view it on any other television set of the house connected to the communications network.

In such a home communications network, it is possible to envisage numerous applications related to the distribution of audiovisual signals.

A first example of an application is that of a person who views a video film on a television set in a certain room of the dwelling. If this person finds that the video may interest other people in other rooms of the dwelling, then he or she may want to tell them about it and suggest that they watch it through the television sets in the other rooms.

A second example of an application is that of a person viewing a video film on a television set in a certain room of the dwelling and wishing to move to another room where he would continue watching the same video film. In this case, he would need practical means to reroute the video stream without having to set up an entirely new connection.

A third example of an application relates to the distribution of a video stream activated by a predetermined signal such as, for example, a motion detector associated with a surveillance camera. To inform persons present in the dwelling, this video stream needs to be directed toward the television stations that are active at this time and to the persons interested in viewing this stream.

In all these examples of applications, there is no a priori knowledge of the destination terminal or terminals to which the audiovisual signal will be finally directed. This represents a new problem to which the connection setup protocols known to those skilled in the art are not suited.

It is indeed well known that, to set up a unicast or multicast connection, it is necessary to know the identifiers or the addresses of the source terminal and of the destination terminal or terminals. This is why the absence of knowledge of the addresses or identifiers of the destination terminals, when a connection is set up, means that the protocols known to those skilled in the art cannot be used.

An example of this type of protocol is described in the IEEE 1394.1 standard which specifies the mechanisms of a bridge for the interconnection of digital serial buses compliant with the IEEE 1394 bus standard. Section 4.6 of this IEEE 1394.1 standard describes the parameters of the connection set-up message (called “JOIN”) for the transportation of an isochronous stream between the source (“or talker”) and a destination (or “listener”). These parameters must contain especially the identifier of the source (“EUI_{—}64 talker”) and the address of the destination (“listener_ID”).

Furthermore, there are broadcast protocols that enable the broadcasting of an audiovisual signal to all the terminals of the network, hence broadcasting without a priori knowledge of the listeners. However the broadcasting is done “blindly” and all the terminals are not necessarily final listeners; i.e. terminals really concerned by the signal. Furthermore it is frequent, as in the case of the applications referred to further above, that the final listeners represent only a small proportion of the totality of the terminals of the communications network and, therefore, the transportation of the audiovisual signals to all the terminals unnecessarily consumes the resources of the network (especially bandwidth).

Indeed, in networks based on non-shared transmission media such as, for example, unicast links connecting all the terminals directly or through switching units, bandwidth has to be reserved on each of the paths to reach all the terminals. It can clearly be seen that the bandwidth of a part, at least, of the paths intended for terminals not concerned by the audiovisual signal will be unnecessarily occupied.

Another drawback in the broadcasting of the audiovisual signal is that the source terminal does not know whether or not the destination terminals are making use of the broadcast signal. This information is, for example, necessary in the case of video surveillance to activate the recording of the audiovisual signal when it is established that no destination terminal is making use of this signal.

### SUMMARY OF THE INVENTION

The method according to the invention overcomes these drawbacks of the prior art. The invention can be used to set up connections for the distribution of an audiovisual signal without a priori knowledge of the destination terminals.

To this effect, the invention according to a first aspect proposes a method for the distribution of an audiovisual signal, in a communications network interconnecting a plurality of terminals, from a source terminal to one or more destination terminals. A method of this kind comprises the steps of:
detecting an initializing signal;
transmitting the audiovisual signal to a first group of terminals;
sending indication messages for indicating the transmission of the audiovisual signal to a second group of terminals or terminal formed by all or part of the terminals of the first group;
receiving confirmation messages to be used for determining the one or more terminals of the second group for which the transmission of the audiovisual signal is to be maintained;
stopping the transmission of the audiovisual signal to the first group of terminals except for the one or more terminals of the second group for which the transmission of this signal is to be maintained.

The general principle of the invention lies in making the audiovisual signal reach the terminals of the communications network that are liable to be concerned by the display of this signal and in informing them of it. It is then determined whether the distribution of the signal to each destination terminal should be maintained or not depending on the user's interest. Thus, the distribution of the audiovisual signal is maintained only for the terminals that are really concerned by the display of the signal, thus optimizing the resources of the communications network.

The distribution of the signal before the final listeners are known has the advantage of increasing the response time when the user agrees to view the signal because the transmission of the signal is already activated toward this destination terminal or listener. Another major advantage is that each user can preview the signal before agreeing or not agreeing to maintain it. In this case, a decision can be taken according to the contents of the audiovisual signal.

In a preferred embodiment of the method of distribution of the audiovisual signal, the communications network is of a switched type. The audiovisual signal is then transmitted in packets that have a routing header enabling them to be conveyed to the destination terminals.

According to a preferred characteristic of the invention, the step of stopping the transmission of the audiovisual signal includes a step of modifying the routing header of the packets conveying this signal so as not to reach the one or more terminals of the first group for which the transmission of the signal is not maintained.

The modification of the routing header enables the stopping of the audiovisual signal for possibly one or more terminals of the first group transparently with regard to the remaining terminals for which the transmitting of this audiovisual signal is to be maintained. In a particular case in which the first group represents all the terminals of the communications network, the modification of the routing header enables the replacement of the broadcasting of the signal to all the terminals by a multicast transmission.

According to another preferred characteristic of the invention, the step of stopping the transmission of the audiovisual signal is performed after the expiry of a time-out with a predetermined value. This leaves time for the users to preview the received signal if necessary. The time-out also prevents an indefinite wait for the transmission of confirmation messages from terminals that are turned off or do not have the means to respond because they are not implementing the invention for example.

In one alternative embodiment of the invention, the initialization signal is a remote-control signal sent by a remote-control unit. The user can thus initiate the distribution of the audiovisual signal through his remote-control unit.

In another alternative embodiment of the invention, the initialization signal is a message sent by any device whatsoever of the communications network. Thus, even if the user is not in the vicinity of the device implementing the invention, he can initiate the distribution of the audiovisual signal by sending a message through the network. In one alternative embodiment, this message can also be generated automatically, following a remote-control signal sent by a remote-control unit.

In another alternative embodiment of the invention, the source terminal is a video surveillance camera and the initialization signal corresponds to the detection of a motion in the audiovisual signal transmitted by this camera. The detection of motion enables the automatic alerting of users who may happen to be located next to destination terminals such as television sets.

According to a preferred characteristic of the invention, the first group is a predetermined set of terminals capable of receiving the audiovisual signal. It is indeed not necessary to send the audiovisual signal to all the destination terminals if some of them are turned off or do not have the means, for example, to read the format of the audiovisual signal. Obviously, if this information is not available, it is enough to choose all the terminals of the communications network as destination terminals.

According to another preferred characteristic of the invention, the second group is constituted by the terminals of the first group that were not receiving the visual signal before the step of transmission of the audiovisual signal. Thus, users who were already viewing the audiovisual signal will not receive an invitation to view the same audiovisual signal again.

Advantageously, the method for distributing an audiovisual signal according to the first aspect of the invention is implemented by a controller associated with the source terminal. Thus, it is easier to command the source terminal, and the modification of the routing header of the packets conveying the signal as a function of the destination terminals is simplified.

According to a second aspect, the invention proposes a method for validating a distribution of an audiovisual signal from a source terminal to a destination terminal in a communications network interconnecting a plurality of terminals. Such a method comprises the steps of:
receiving an audiovisual signal from the source terminal;
receiving an indication message for indicating the transmission of the audiovisual signal by the source;
validating the maintaining of the transmission of the audiovisual signal;
sending a confirmation message containing an information representing the maintaining on non-maintaining of transmission toward the destination terminal of the audiovisual signal.

It is thus possible, after the reception of the indication message on the transmission of the audiovisual signal, to decide whether or not to maintain the transmission of the signal. The decision is taken, for example, as a function of the remote-control signals sent by a remote-control unit interacting with the user.

Advantageously, the method of validating the distribution of an audiovisual signal according to the second aspect of the invention is implemented by a controller associated with the destination terminal. Thus, it is easier to interact with the user through remote-control signals for example.

Correlatively, the present invention relates to a device for distributing an audiovisual signal in a communications network interconnecting a plurality of terminals, from a source terminal to one or more destination terminals. Such a device comprises:
means for detecting an initialization signal;
means for sending the audiovisual signal to a first group of terminals;
means for sending indication messages for indicating the transmission of the audiovisual signal to a second group of terminals or terminal constituted by all or part of the terminals of the first group;
means for the reception of confirmation messages enabling the determining of the one or more terminals of the second group for which the sending of the audiovisual signal is to be maintained; and
means for stopping the transmission of the audiovisual signal to the first group of terminals except for the one or more terminals of the second group for which the transmission of this signal is to be maintained.

The present invention also relates to a device for validating a distribution of an audiovisual signal from a source terminal to a destination terminal in a communications network interconnecting a plurality of terminals, wherein the device comprises:
means for receiving an audiovisual signal from the source terminal;
means for receiving an indication message for indicating the transmission of the audiovisual signal by the source;
means for validating the maintaining of the transmission of the audiovisual signal;
means for sending a confirmation message containing an information representing the maintaining or non-maintaining of transmission toward the destination terminal of the audiovisual signal.

These devices for the distribution of an audiovisual signal and for the validation of this distribution have characteristics and advantages similar to those of the method that they implement.

The present invention furthermore relates to an information storage means, which if necessary is totally or partially removable, readable by a data-processing system, comprising instructions for a computer program adapted to implementing the methods described here above according to the different aspects of the present invention.

Finally, the invention relates to a computer program readable by a microcontroller, comprising software code portions adapted to implementing the methods described here above according to the different aspects of the present invention, when this computer program is loaded and executed by the microcontroller.

These information storage means and computer program have characteristics and advantages similar to those of the methods that they implement.

### BRIEF DESCRIPTION OF THE DRAWINGS

The characteristics and advantages of the invention shall appear more clearly from the description of a preferred embodiment of the invention, given by way of an indicative and non-exhaustive example, and from the appended figures, of which:

FIG. 1 shows the steps of the method for setting up a connection according to a first characteristic of the invention;

FIG. 2 shows a home communications network in which the invention can be implemented in a preferred way;

FIG. 3 shows the format of a data packet traveling in transit through the home communications network;

FIG. 4 is a block diagram of a device according to the invention;

FIG. 5 is a remote-control unit used to implement the method of the invention;

FIG. 6 describes the steps of the procedure for the distribution of the AV signal in the context of a first application of the invention;

FIG. 7 describes the steps of the procedure for the validation of the distribution of an AV signal according to an alternative implementation of the invention.

### MORE DETAILED DESCRIPTION

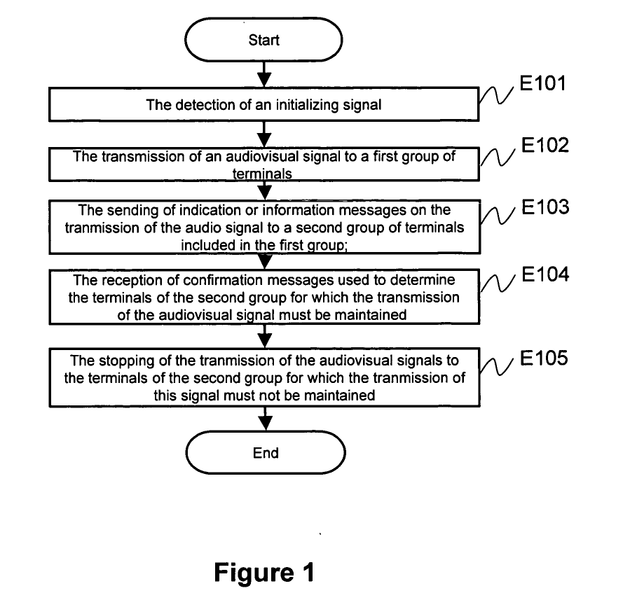

Referring to FIG. 1, a description is given of the steps of the method of distribution of an audiovisual signal according to a first characteristic of the invention.

The method of distribution of the AV signal is activated following the detection of an initialization signal (E101). This initialization signal may correspond to various events according to applications implementing the invention such as, for example, pressure applied by a user on a particular key of a remote-control device or the detection of a movement through the AV signal sent out by a video surveillance camera. Further details on the initialization signal and the possible events are given in the description further below of alternative embodiments of the method.

Following the detection of the initialization signal, the AV signal to be distributed is transmitted to a first group of terminals (E102). This first group may consist of all the terminals of the home communications network or of a part of these terminals. For example, it is not necessary to include, in the first group, terminals that are not intended for the viewing of the AV signal or terminals that are unsuited, because of their state or their means, to the reception of the signal. Thus, in one variant, it is possible to constitute a first group with only the terminals that have means for the reception of the AV signal or are compatible with its format.

An indication message is then transmitted to a second group of terminals enabling them to come to know the AV signal (E103). The indication messages are necessary because the transmission of the signal to the terminals is not enough for it to be taken into account; the destination terminal must configure its communications interface to activate the connection. The indication message is used to initiate this configuration if the destination terminal is concerned by the AV signal.

The second group is constituted by a part or by all the terminals of the first group. Indeed, in certain scenarios, it is desirable to exclude certain terminals from the first group such as, for example, terminals that were already receiving the AV signal before the step E102 for the transmission of this signal.

To prevent the continual transmission of the AV signal toward the terminals that are not concerned by this signal, and therefore do not make use of it, a confirmation step (E104) is necessary. The reception of confirmation messages from the terminals of the second group can be used to determine those terminals to which the transmission of the AV signal must be maintained. In one example of the implementation of this step, only the terminals concerned by the signal send a confirmation message. In another example, all the terminals must send a confirmation message indicating their state. However, there are various possible alternative embodiments, within the scope of those skilled in the art, for implementing the invention.

Finally, in the step E105, the is a stopping of transmission of the AV signal toward terminals of the sub-group that had received it in the step E102 but, as determined in the step E104, are not interested in receiving this AV signal.

There are several embodiments that can be used to perform the steps of the method described in FIG. 1, depending on the application to be implemented.

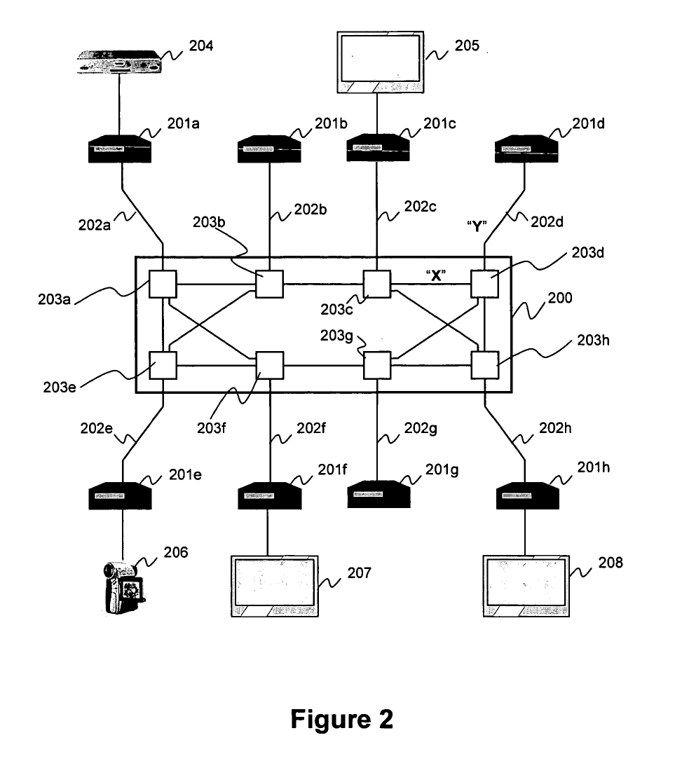

To describe these different embodiments, we shall consider a home communications network represented in FIG. 2, in which the invention can be implemented in a preferred but non-exhaustive manner.

This network has a set of nodes referenced 201a, 201b, 201c, 201d, 201e, 201f, 201g and 201h representing multimedia interface devices. Each node is typically placed in a room of the dwelling and thus enables the connection of the terminals located in this room to other terminals located in other rooms of the dwelling. The nodes are connected to a central switch 200 through links referenced 202a, 202b, 202c, 202d, 202e, 202f, 202g and 202h. These links are for example of the UTP5 (“Unshielded Twisted Pair, category 5”) type as specified in the ANSI/TIA/EIA/568A standard classically used in networks of the Ethernet II type. It must be noted that other types of links such as fiber-optic links may be used.

The nodes as well as the switch form a backbone network enabling the exchange of data between terminals in the dwelling.

The switch consists of a set of switching units 203a, 203b, 203c, 203d, 203e, 203f, 203g and 203h that enable the routing of the data between the nodes. In this example, each switching unit has three ports of a first type called “X” ports enabling the switching units to be connected to one another, and one port of a second type called a “Y” port enabling a switching unit to be connected to a node. The “X” type nodes are connected by links internal to the switch 200 (also called X links), and the “Y” type ports are connected to the nodes by external links (also called Y links). The two types of links may have different characteristics, such as for example the maximum bit rate of the data that they may carry.

In one alternative embodiment of the switch, the switching units are distributed at the level of the nodes. The links connecting the “X” ports thus become external links and the links connecting the “Y” ports to the nodes become internal links. The number of switching units as well as the way in which they are connected may also vary.

The following terminals are also considered to be connected to the backbone network: a set-top box referenced 204 is connected to the node 201a, a digital camera referenced 206 is connected to the nodes 201e and television sets 205, 207 and 208 are respectably connected to the nodes 201c, 201f and 201h.

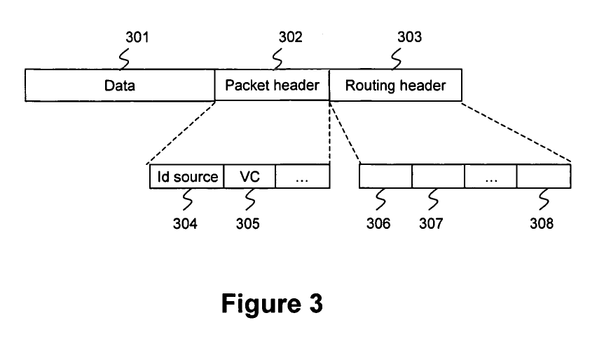

The nodes exchange data with one another in using data packets that will be conveyed through the switch. FIG. 3 illustrates the format of a data packet used in the context of the invention. The packet contains a “data” field 301 in which the useful data are conveyed, a “packet header” field 302 containing linking information and a “routing header” field 303 containing the information necessary to convey the packet from the source node to the destination nodes.

The field 302 contains, for example, the address or identifier of the source node 304 and virtual channel number 305 corresponding to the connection made.

The technique used for the conveyance of the packets is a “source routing” technique. With this technique, the routing header consists of a plurality of fields 306, 307, 308v containing the numbers of the output ports of each switching unit that the packet must cross. Each node wishing to transmit a packet sets up this sequence knowing the architecture of the switch 200. In general, there may be several paths existing to serve one or more nodes. The choice between several routing paths depends on the quality of service to be offered and the bandwidth available at the links connecting the switching units.

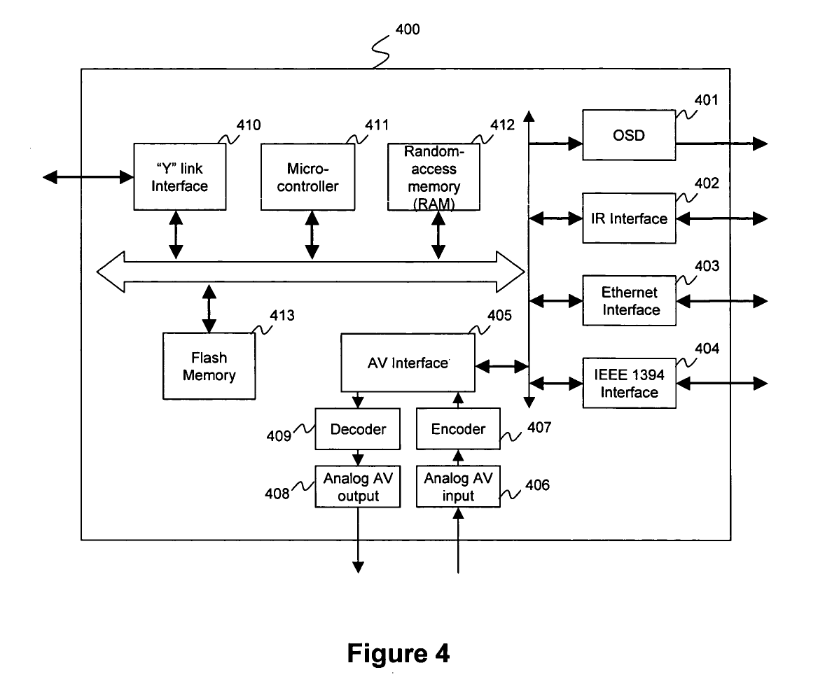

FIG. 4 is a block diagram of a node. In general, the multimedia interface equipment has a plurality of connection means by which signals of different natures will be processed. The data coming from the connection means will be intermingled to form only one datastream that will be carried on the Y link according to a predetermined protocol. The nodes thus enable the connection, to the home network, of devices such as for example analog input television sets, videocassette recorders, DVD readers, IEEE1394-compatible digital terminals and/or computers.

The node has a microcontroller 411 that will transfer information coming from different interfaces to the memory 412 or directly toward the FIFO (“First In First Out”) type transmission memories of the output interfaces (401, 402, 403, 404, 405).

The microcontroller 411 is also responsible, when the node is powered on, for loading the program that implements the invention, stored in the rewritable permanent memory (“flash” memory) 413, into the random-access memory 412 in order to execute the code instructions associated with this program.

The node has a set of physical interfaces according to different communications standards with circuits or associated linking programs. The interfaces are, for example, an Ethernet type interface referenced 403 enabling the exchange of data with terminals such as computers, an interface referenced 404 for the exchange of isochronous and asynchronous data on a bus with IEEE1394-compatible terminals, an interface referenced 402 for the sending or reception of infrared signals for the exchange of commands, or an interface 410 enabling the exchange of data on the Y link with the switch 200.

The node can also be interconnected on analog equipment. To this end, it has an analog input module 406 enabling the analog/digital conversion of AV signals at input and a module 407 for encoding this signal in the form of an encoded AV signal (using the MPEG2, DV, or similar format). This interface may have an analog audio/video source, such as a set-top box with an analog output for example, connected to it. For the output AV signals, a module referenced 409 enables the decoding of an encoded AV signal before its conversion into an analog signal in the output module 408. This interface may have audio/video equipment, such as for example a television set or an analog display screen, connected to it. The management of the reception and of the transmission of the encoded AV signal is done by the AV interface referenced 405.

The module referenced 401 contains a character generator that enables the insertion of information by overlay on the output AV signal (using the “On Screen Display” technique). This information is intended for the user and enables him, for example, to receive information messages on the display screen. The association of the information received by this interface with commands sent by the user through the infrared interface 402 enables navigation in a menu, the commanding of an action, a setting or selection operation, or the control of devices of the network.

The user may transmit his commands to the node by means of a remote-control device. A remote-control device is associated with each node of the backbone network. This remote-control device may be dedicated to the node or it may be a multifunctional device also enabling the control of one or more other terminals connected to the node such as a television set.

Here below in the description, the term “controller” designates the function of a node enabling the processing of the commands received through the infrared interface 402, the sending of messages through the OSD module 401 and the management of the connections for the transmission or reception of data through the node. It is considered, in the preferred embodiment of the invention, that there is a controller in each node enabling the configuration of this node or of the terminals that are connected to it.

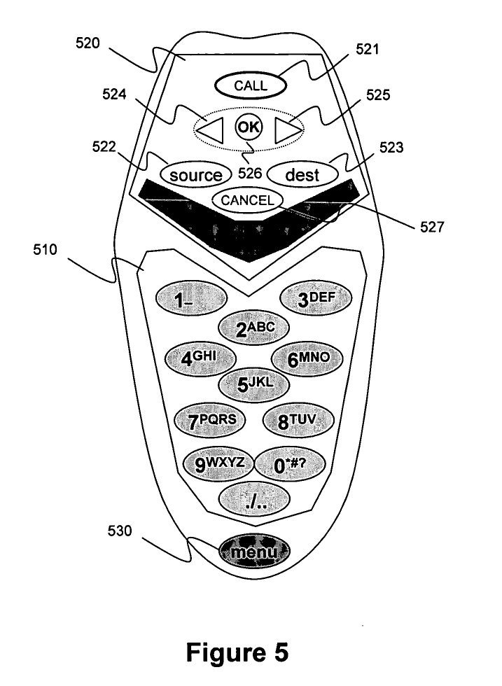

FIG. 5 gives a view, by way of an illustration, of a remote-control unit that can be used to send commands to initiate the distribution of an AV signal according to the invention. A remote-control unit of this kind comprises, for example, three sets of keys:
a first set of alphanumeric keys referenced 510;
a second set of keys comprising specific command keys referenced 520;
a key referenced 530, enabling the user to access a menu, for example to execute complementary functions that could be implemented within the audiovisual network.

The specific command keys include for example:
a “CALL” key referenced 521 whose use in the context of the invention is given here below in the description;
a “source” key referenced 522 for the selection of a source of an AV signal;
a “dest” key referenced 523 to select a listener of an AV signal;
navigation keys 524 and 525 to scan a list of several terminals of channels during a selection;
an “OK” key referenced 526 to validate the choice of an element of a list or menu;
a “CANCEL” key referenced 527 to cancel a choice or action or to exit a menu.

Here below in the description, the names assigned to the keys are used also to designate the remote-control signals (or commands) sent when the user presses these keys.

In the context of the home communications network described further above, we consider a first application in which a first user views a AV signal on the television sets referenced 205, this signal coming from the set-top box 204. In the presence of a content that may interest other users, this user decides to invite them to watch the AV signal in progress.

The goal is to distribute the AV signal to the different nodes of the home communications network and invite potential users, placed before the television sets connected to the analog AV outputs of the nodes, to watch the proposed AV signal. Clearly, there is not necessarily one user before each television set, and also there is not necessarily a television set connected to each node (in FIG. 2 only the nodes 201c, 201f and 201h have a television set connected to output).

To achieve this goal, the user presses the “CALL” key of his remote-control device and thus transmits this command to the multimedia interface equipment referenced 201c which is close to him and to which the television set 205 is connected. The “CALL” command is intercepted by the controller of the multimedia interface equipment 201c which is designated as the first controller. The term “second controller” also designates the controller of the multimedia interface equipment referenced 201a; this multimedia interface equipment is responsible for the management of the source terminal (the set-top box) 204.

In one alternative embodiment, the multimedia interface equipment 201c directly incorporates a key having a function similar to that of the “CALL” key of the remote-control unit. The user can thus apply direct pressure on this key to send his command to the first controller.

Since the source terminal and the display terminal are connected to different multimedia interface devices, a message is sent from the first controller to the second controller so that the latter executes the procedure for the distribution of the AV signal.

The message contains at least the following elements:
a routing header to reach the node 201a. This header is built according to the technique described further above, from the address of the node 201a.

The address of the node 201a is determined by the first controller from the “source id” field contained in the packets that convey the AV signal from the node 201a to the node 201c for display on the television set 205;
the address of the source node 201c;
the number of the virtual channels corresponding to the AV signal to be distributed;
the type of message (corresponding to the “CALL” command) informing the second controller of the action to be performed upon reception of this message;
as the case may be, an information message intended for the final user.

It can be noted that, in this application, the signal to be distributed is by default the signal being viewed by the user. In a more general embodiment, it may be that the signal to be distributed cannot be defined when the “CALL” command is sent because it is not being displayed or because several AV signals are being distributed at the same time by the node (for example to a digital terminal). In this variant, the user will be invited to specify the AV signal to be distributed by selecting a source and a channel through a menu for example.

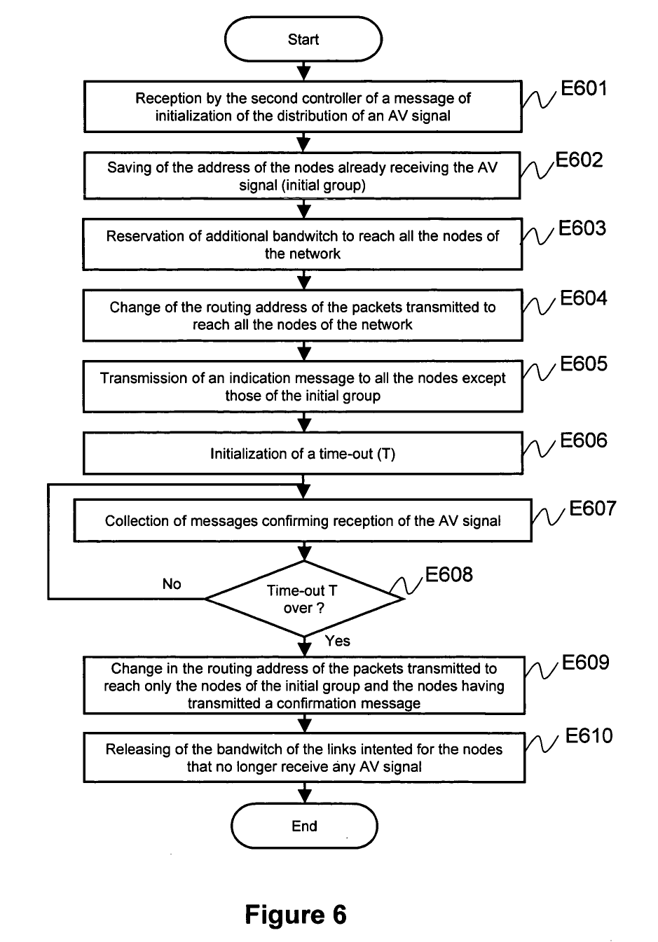

FIG. 6 describes the steps of the procedure for the distribution of the AV signal in the context of the first application.

The reception by the second controller of the message corresponding to the “CALL” command transmitted by the first controller initializes the procedure (step E601). In this step, the second controller determines the parameters of the connection to be made and those of the signal to be distributed.

In one alternative embodiment in which the source 204 and the television set 205 are connected to a same node (for example 201a), it is the controller of this node that manages both terminals. It is clear that, in this case, the initialization signal will be the “CALL” command sent by the remote-control device.

In the step E602, the second controller saves the parameters of the connection already made to the terminal 205. Indeed, this connection must be held even if the distribution of the AV signal to other terminals fails (unless it is explicitly interrupted by the use). In general, a connection may be initially set up to distribute the AV signal to several destination terminal; these terminals constitute a group called the “initial group”. This connection should be maintained with respect to all the terminals of this initial group and should not be disturbed by the user's operations.

Since the destination terminals considered are analog television sets, the connections are really set up between the nodes of the backbone network. Each node is then responsible for rerouting the AV signal to its analog output interface 405. In the step E603 the second controller reserves the additional bandwidth necessary to distribute the signal to all the nodes of the network. If the bandwidth is not enough, it may be that not all the nodes are concerned, or a lower quality of the signal may be accepted.

The step E604 consist in changing the routing header of the packets conveying the AV signal so that the packets are distributed to all the multimedia interface devices of the communications network. It must be noted that this operation is transparent for the television set 205 which undergoes no interruption in the distribution of the AV signal. Indeed, the technique of routing to the source enables a simple adaptation of the listeners of a datastream by the source node without disturbing the nodes that are already receiving this stream.

In the step E605, the second controller informs the controller of each node, except those connecting the terminals of the initial group, of the existence of the AV signal by transmitting an indication message to them.

This message consists of a routing header that enables it to reach the destination nodes and a data field. The data field contains for example:
the type of message that enables the node receiving this message to determine the action to be performed;
the parameters of the connection pertaining to the distributed AV signal, representing at least the source address (ID1) and the virtual channel number (VC1). These parameters enable the identification of the packets of the AV signal by comparison with the fields 304 and 305 of the set of packets received by the node; and
as the case may be, an information message communicated by the user who has initiated the connection.

The controller of each destination node of the indication message overlays a text message on the AV signal at output of its analog interface. This text message informs the user of the possibility of viewing the AV signal. If an information message is present in the indication message, it is also displayed for the user (this may be for example a message on the content). The display of the message uses the character generator 401 of the destination node.

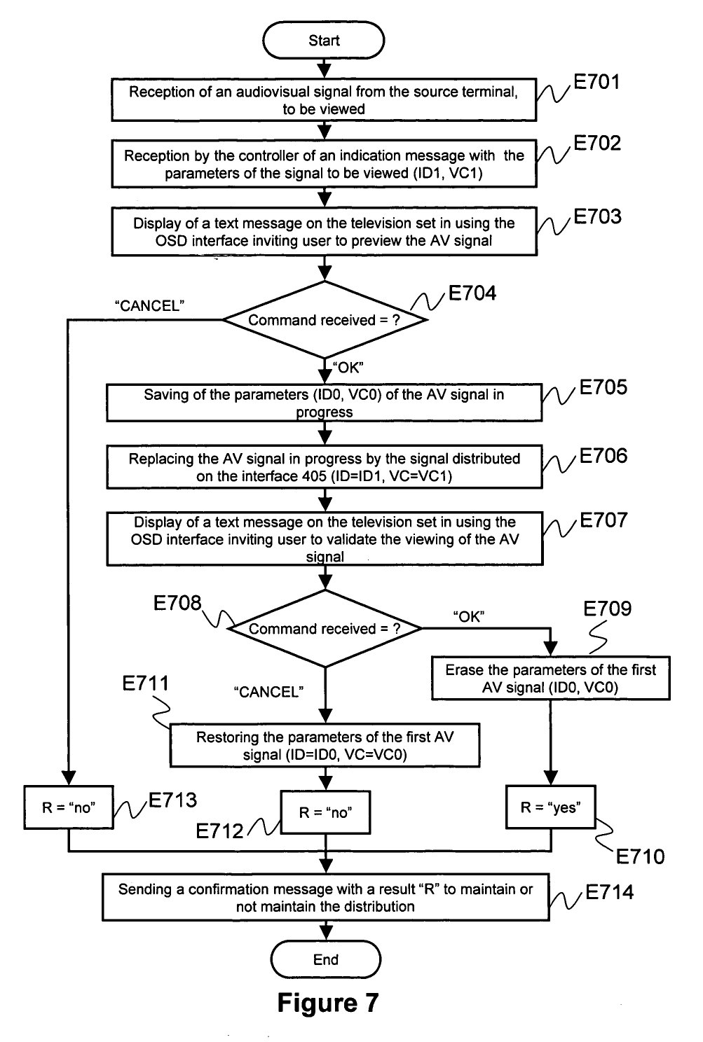

The text message is effectively viewed if a terminal (a television set) is connected to the node and if this terminal is active. In this case, the user may accept or reject the display of the AV signal in sending, for example, specific commands through the remote-control device (for example the “OK” or “CANCEL” commands). A second message may then be displayed by the controller to request the user to validate the viewing of the AV signal or to stop it and return to the previous AV signal (in still using, for example, the “OK” and “CANCEL” commands). Further details are given in FIG. 7 which describes an example of a processing procedure used by the controllers of the nodes of the indication messages.

In one alternative embodiment, following the reception of the indication message, the controller of the destination node directly overlays the transmitted AV signal on the AV signal being viewed on the destination television set (this is known as the “picture-in-picture” property) in addition to the information message. The user may thus directly validate the viewing of the AV signal for normal display or may reject the viewing. Naturally, the overlay technique does not apply in the case of a pure audio signal. For this type of signal, the technique used to display a message remains preferable.

The controller of each destination node then transmits a confirmation message depending on the user's response. A confirmation message may be transmitted only if the AV signal has to be maintained, or else in both cases with a piece of information on maintaining or not maintaining the signal and, as the case may be, an information message.

During a period of time T, the second controller collects the confirmation messages transmitted by the controllers to determine those that wish to maintain the distribution of the AV signal (steps E606, E607 and E608). The time-out may be chosen to be sufficiently lengthy to leave time for the users to preview the AV signal and respond if necessary.

The time-out is necessary especially in an alternative mode of implementation where certain controllers who have to transmit the confirmation message are implemented in devices that may be off (for example a digital television set that has its own controller). In this case, the confirmation message is not transmitted (the distribution of the AV signal is not maintained).

In the preferred embodiment, the controllers are in the nodes of the backbone network, and these nodes are considered to be always active. It is considered then that the controllers of these nodes are still transmitting a confirmation message containing a piece of information to determine whether the distribution of the AV signal has to be maintained or not.

In the step E609, the second controller changes the routing address of the packets transmitted to reach only the nodes of the initial group and the nodes wishing to maintain the transmission of the AV signal.

In the step E610, the second controller, as the case may be, releases the bandwidth that has been reserved on links intended for the nodes that no longer received any AV signal.

The procedure described further above can be used in the case of a variant of the first application, in which the user moves from a first room to a second room of the dwelling and wishes to continue viewing the same AV signal. Indeed, the user starts by sending the “CALL” command at the node of the first room and will then validate the viewing of the AV signal at the node of the second room.

In one alternative embodiment, in order to stop the viewing of the signal on the first television set (and hence stop the transmission of this signal to the first node), the users sends, for example, a specific command (STANDBY) for example) following the “CALL” command. The first controller therefore sends a message so that the second controller stops the connection to the first node.

We shall also consider another application of the invention in which the AV signal to be distributed comes from a video surveillance camera. To illustrate this application, it is assumed that the camera 206 is placed in an infant's room in order to monitor this infant. The parents may link up from a distance on this camera to look at their child when he is awake, or pass into automatic surveillance mode when he is asleep. In this case, the parents or other persons in the house are invited to view the AV signal coming from the camera only if there has been a detection of unusual movements or sounds (such as shouts, crying, disturbed movements etc).

To implement this application, a procedure similar to that of FIG. 6 is executed. The particular features of this implementation are described in detail here below.

The node 201e executes the program for the analysis of the AV signal received from the camera 206. This analysis enables the detection of movements or sounds according to techniques known to those skilled in the art. If the movements or sounds detected are significant (if their value exceeds a predetermined threshold) an initialization signal is sent to initialize the procedure of FIG. 6 (steps E601). However, the sending of the initialization signal is internal to the node and is not performed by a remote controller.

The indication message transmitted by the controller of the node 201e in the step E605 may contain an information message pre-recorded in the memory 403 of the node to inform users, for example, that the AV signal proposed corresponds to that of a video surveillance camera.

By way of an example, we shall consider another alternative application in which the AV signal comes from a videophone positioned at the entry to the dwelling. It is assumed that this videophone represents a digital terminal (source terminal) connected to one of the nodes of the backbone network by a digital link (an IEEE 1394 link for example).

This videophone has a ringing system associated with it. Once activated, this ringing system sends an initialization signal to the controller of the node (in this case, the first and second controllers are indistinguishable) to distribute the AV signal coming from the videophone to viewing terminals inside the dwelling. The initialization signal may take the form of an asynchronous message compliant with the IEEE 1394 standard. This message contains, among other pieces of information, the number of the IEEE 1394 channel on which the source terminal will transmit the AV signal to the node. After reception of this message, the controller of the node can configure the registers of its IEEE 1394 interface (404) to receive the AV signal. The reception of the asynchronous message also makes it possible to initialize the method of the invention (FIG. 6) to distribute the AV signal received from the source terminal.

It can be noted that if the videophone is of an analog type, the connection between the videophone and the node is of an analog type similar to the connection of the video surveillance camera 206 to the node 201e. In this case, the link-up node, in addition to the input/output interfaces shown in FIG. 4, incorporates an additional interface enabling the reception of a ringing signal (the signal can be multiplexed with the AV signal or transmitted on an independent link). This signal is then taken as an initialization signal by the controller of the node to distribute the AV signal.

FIG. 7 describes the steps of the procedure for validating the distribution of an AV signal according to an alternative mode of implementation of the invention. This procedure is implemented by the controllers which manage the connections to the destination terminals and are recipients of the indication message transmitted by the second controller. It may be recalled that, in the example of the communications network of FIG. 2, the controllers of the analog television sets are localized in the link-up nodes of these television sets (namely the nodes through which these television sets are attached to the network).

In the step E701 the node receives the AV signal distributed by the source terminal. This signal corresponds to the signal to be viewed.

In the step E702, the controller receives the indication message and determines the parameters ID1 and VC1 of the signal to be viewed and, possibly, the information message, conveyed in the data field of this indication message.

In the step E703, using the OSD interface 401, the controller overlays a text message on the AV signal at output of its analog interface 405. This text message is intended for the user and invites him to preview the AV signal. If an information message is present in the indication message, it is also included in the text message.

In the step E704, the controller tests the command received through the interface 402, sent by the remote-control unit. If the received command is the “CANCEL” command then, in the step E713, the controller initializes a variable R at “no” indicating a refusal to continue the viewing of the AV signal. If the command received is “OK”, then in the step E705, the controller saves the parameters of the AV signal already being viewed in the television set (ID0 and VC0).

It is assumed that the variables ID and VC contain the address and virtual channel number parameters of the packets corresponding to the AV signal which is viewed on the television set. These variables initially contain the values ID0 and VC0. In the step E706, the values ID1 and VC1 are assigned to the variables ID and VC in order to replace the AV signal viewed on the television set.

In the step E707, the controller, using the OSD interface 401, overlays a text message on the AV signal at output of its analog interface 405. This text message is intended for the user and invites him to view the AV signal.

In the step E708, the controller tests the command received through the interface 402 and sent to the remote-control unit.

If the command received is a “CANCEL” command, the controller restores the parameters of the AV signal which were being viewed (first signal) before the previewing of the new signal. For this purpose, the previously saved values ID0 and VC0 are reassigned to the variables ID and VC in the step E711. In the step E712, the controller also initializes the variable R at “no”.

If the command received is “OK”, then in the step E709, the controller erases the saved parameters ID0 and VC0 and, in the step E710, initializes the variable R at “yes”.

Finally, in the step E714, the controller sends the second controller a confirmation message containing the variable R by which it is possible to determine whether or not to maintain the distribution of the AV signal to the terminal that is associated with it.

Naturally, many modifications can be made to the examples of embodiments described here above without departing from the scope of the invention.

1. A method for distributing an audiovisual signal, in a communications network interconnecting a plurality of terminals, from a source terminal to one or more destination terminals, wherein the method comprises the steps of:
detecting an initializing signal;
transmitting the audiovisual signal to a first group of terminals;
sending indication messages for indicating the transmission of the audiovisual signal to a second group of terminals or terminal formed by all or part of the terminals of the first group;
receiving confirmation messages to be used for determining the one or more terminals of the second group for which the transmission of the audiovisual signal is to be maintained; and
stopping the transmission of the audiovisual signal to the first group of terminals except for the one or more terminals of the second group for which the transmission of this signal is to be maintained.

2. A method according to claim 1, wherein the communications network is of a switched type in which the audiovisual signal is transmitted in packets each comprising a routing header and the stopping step includes a step of modifying the routing header of the packets conveying this signal so as not to reach the one or more terminals of the first group for which the transmission of the signal is not maintained.

3. A method according to claim 1, wherein the absence of receiving a confirmation message from a destination terminal before the expiry of a time-out of a predetermined value makes it possible to determine that the transmission towards this terminal is not to be maintained.

4. A method according to claim 1, wherein the initialization signal is a remote-control signal sent by a remote-control unit.

5. A method according to claim 1, wherein the initialization signal is a message sent by a node of a switched backbone network to which there is connected a terminal that was initially receiving the audiovisual signal before the step of transmitting of the audiovisual signal.

6. A method according to claim 5, wherein the sending of the message is activated by the reception, by the node, of a remote-control signal sent by a remote-control unit.

7. A method according to claim 5, wherein the transmission of the message is activated by pressure on at least one predetermined key incorporated into the node.

8. A method according to claim 1, wherein the source terminal is a video surveillance camera and wherein the initialization signal corresponds to the detection of a motion in the audiovisual signal transmitted by this camera.

9. A method according to claim 1, wherein the source terminal is a videophone and wherein the initialization signal corresponds to pressure on a ringing button associated with this videophone.

10. A method according to claims 1, wherein the first group is constituted by all terminals connected to the communications network and the transmitting step is performed by a broadcasting mechanism.

11. A method according to claim 1, wherein the first group is a predetermined set of terminals capable of receiving the audiovisual signal.

12. A method according to claim 11, wherein a terminal is considered to be capable of receiving the audiovisual signal if it can process the format of this signal.

13. A method according to claim 1, wherein the second group is constituted by the terminals of the first group that were not receiving the visual signal before the step of transmitting of the audiovisual signal.

14. A method for validating a distribution of an audiovisual signal from a source terminal to a destination terminal in a communications network interconnecting a plurality of terminals, wherein the method comprises the steps of:
receiving an audiovisual signal from the source terminal;
receiving an indication message for indicating the transmission of the audiovisual signal by the source;
validating the maintaining of the transmission of the audiovisual signal; and
sending a confirmation message containing an information representing the maintaining on non-maintaining of transmission toward the destination terminal of the audiovisual signal.

15. A method according to claim 14, wherein the validating step comprises a receiving step of a remote-control signal transmitted from a remote-control unit that makes it possible to determine the information representing the maintaining or non-maintaining of the transmission of the audiovisual signal.

16. A method according to the claim 14, wherein it is implemented by a controller associated with the destination terminal.

17. A device for distributing an audiovisual signal in a communications network interconnecting a plurality of terminals, from a source terminal to one or more destinations,
wherein the device comprises:
means for detecting an initialization signal;
means for sending the audiovisual signal to a first group of terminals;
means for sending indication messages for indicating the transmission of the audiovisual signal to a second group of terminals or terminal constituted by all or part of the terminals of the first group;
means for the reception of confirmation messages enabling the determining of the one or more terminals of the second group for which the sending of the audiovisual signal is to be maintained; and
means for stopping the transmission of the audiovisual signal to the first group of terminals except for the one or more terminals of the second group for which the transmission of this signal is to be maintained.

18. A device for distributing an audiovisual signal according to claim 16, wherein the communications network in which it is incorporated is of a switched type network and wherein the sending means comprise means for constituting packets comprising a routing header compliant with this type of network to convey the audiovisual signal.

19. A device for distributing an audiovisual signal according to claim 17, wherein the means for stopping the transmission of the audiovisual signal include means for modifying the routing header of the packets so that they are not distributed to the terminals of the first group for which the transmission of the audiovisual signal is not maintained.

20. A device for distributing an audiovisual signal according to claim 16, wherein it is incorporated into the source terminal.

21. A device for distributing an audiovisual signal according to claim 16, wherein it is incorporated into a node to which the source terminal is connected, and forming part of a switched backbone network constituted by a plurality of nodes to which the terminals of the communications network are connected.

22. A device for distributing an audiovisual signal according to claim 16, wherein the means for detecting an initialization signal use an information contained in remote-control signals sent by a remote-control unit and received by a receiving means.

23. A device for distributing an audiovisual signal according to claim 16, wherein the means of detection of an initialization signal use an information contained in messages transmitted by any device whatsoever of the communications network and received by a receiving means.

24. A device for distributing an audiovisual signal according to claim 16, wherein the source terminal is a video surveillance camera and wherein the means for detecting an initialization signal comprise means for detecting motion in the audiovisual signal transmitted by this camera.

25. A device for distributing an audiovisual signal according to claim 16, wherein the means for the transmission of the audiovisual signal comprise means for the broadcasting of this signal.

26. A device for distributing an audiovisual signal according to claim 22, comprising means to determine the terminals of the communications network that are capable of receiving the audiovisual signal that it distributes.

27. A device for distributing an audiovisual signal according to claim 16, comprising means incorporated in:
a microcontroller;
a random-access memory;
a rewritable permanent memory;
interfaces for the exchange of signals at input and output between the device and other devices of the communications network.

28. A device for validating a distribution of an audiovisual signal from a source terminal to a destination terminal in a communications network interconnecting a plurality of terminals, wherein the device comprises:
means for receiving an audiovisual signal from the source terminal;
means for receiving an indication message for indicating the transmission of the audiovisual signal by the source;
means for validating the maintaining of the transmission of the audiovisual signal; and
means for sending a confirmation message containing an information representing the maintaining or non-maintaining of transmission toward the destination terminal of the audiovisual signal.

29. A device for validating a distribution of an audiovisual signal according to claim 28, wherein the means for validating comprise means for receiving a remote-control signal sent by a remote-control unit that makes it possible to determine the information representing the maintaining or non-maintaining of the transmission of the audiovisual signal.

30. A device for validating a distribution of an audiovisual signal according to claim 28, wherein it is incorporated into a node to which the source terminal is connected, and forming part of a switched backbone network constituted by a plurality of nodes to which the terminals of the communications network are connected.

31. A device for validating a distribution of an audiovisual signal according to claim 28, comprising means incorporated in:
a microcontroller;
a random-access memory;
a rewritable permanent memory;
interfaces for the exchange of signals at input and output between the device and other devices of the communications network.

32. An information storage means which is totally or partially removable, readable by a data-processing system, the means comprising instructions for a computer program adapted to implementing the method for distributing an audiovisual signal according to claim 1.

33. An information storage means which is totally or partially removable, readable by a data-processing system, the means comprising instructions for a computer program adapted to implementing the method of validation of the distribution of an audiovisual signal according to claim 14.

34. A computer program readable by a microcontroller, comprising software code portions adapted to implementing the method for distributing an audiovisual signal according to claim 1, when this computer program is loaded and executed by the microcontroller.

35. A computer program readable by a microcontroller, comprising software code portions adapted to implementing the method for validating a distribution of an audiovisual signal according to claim 14, when this computer program is loaded and executed by the microcontroller.
